(19) United States
(12) Patent Application Publication
(10) Pub. No.: US 2018/0139761 A1
(43) Pub. Date: May 17, 2018

(54) METHOD OF COEXISTANCE FOR NARROWBAND TRANSMISSIONS IN 2.4/5 GHZ BANDS

(71) Applicant: INTEL CORPORATION, SANTA CLARA, CA (US)

(72) Inventors: Minyoung PARK, Portland, OR (US); Ilan SUTSKOVER, Hadera (IL); Shahrnaz AZIZI, Cupertino, CA (US); Thomas J. KENNEY, Portland, OR (US); Eldad PERAHIA, Portland, OR (US)

(21) Appl. No.: 15/352,981

(22) Filed: Nov. 16, 2016

(51) Int. Cl. H04W 72/08; H04W 24/08

(52) U.S. Cl. CPC H04W 72/085; H04W 24/08

(57) ABSTRACT

Today's IEEE 802.11 devices operating in the 2.4/5 GHz bands use a 20 MHz channel as a basic operation unit to maintain coexistence with other 802.11 devices. One exemplary aspect is directed toward using a narrower signal bandwidth (e.g. 2 MHz) in the 2.4/5 GHz bands to reduce transmit/receive power consumption or increase transmission range. However, one problem with introducing a narrow bandwidth signal is how to maintain the coexistence between a legacy IEEE 802.11 device that uses a 20 MHz signal bandwidth and a new IEEE 802.11 device that uses a narrower signal bandwidth.

### TECHNICAL FIELD

An exemplary aspect is directed toward communications systems. More specifically an exemplary aspect is directed toward wireless communications systems and even more specifically to IEEE (Institute of Electrical and Electronics Engineers) 802.11 wireless communications systems. Even more specifically, exemplary aspects are at least directed toward one or more of IEEE (Institute of Electrical and Electronics Engineers) 802.11ac/an/ax/ay communications systems, 60 GHz communications systems, mmWave communications systems, IEEE 802.11TGay communications, MU-MIMO communications systems and in general any wireless communications system or protocol, including WiGig, 4G, 4G LTE, 5G and later, and the like. Exemplary aspects are further directed toward incorporating the technology discussed herein into wearables, IoT devices (Internet of Things) and in general any wireless device.

### BACKGROUND

Wireless networks transmit and receive information utilizing varying techniques and protocols. For example, but not by way of limitation, two common and widely adopted techniques used for communication are those that adhere to the Institute for Electronic and Electrical Engineers (IEEE) 802.11 standards such as the IEEE 802.11n standard, the IEEE 802.11ac standard and the IEEE 802.11ax standard.

The IEEE 802.11 standards specify a common Medium Access Control (MAC) Layer which provides a variety of functions that support the operation of IEEE 802.11-based Wireless LANs (WLANs) and devices. The MAC Layer manages and maintains communications between IEEE 802.11 stations (such as between radio network interface cards (NIC) in a PC or other wireless device(s) or stations (STA) and access points (APs)) by coordinating access to a shared radio channel and utilizing protocols that enhance communications over a wireless medium.

IEEE 802.11ax is the successor to 802.11ac and is proposed to increase the efficiency of WLAN networks, especially in high density areas like public hotspots and other dense traffic areas. IEEE 802.11ax also uses orthogonal frequency-division multiple access (OFDMA), and related to IEEE 802.11ax, the High Efficiency WLAN Study Group (HEW SG) within the IEEE 802.11 working group is considering improvements to spectrum efficiency to enhance system throughput/area in high density scenarios of APs (Access Points) and/or STAs (Stations).

Millimeter wave (mmWave) wireless technology generally corresponds to the portion of the radio spectrum between 30 GHz to 300 GHz, with corresponding wavelengths between one and ten millimeters. For wireless communications, mmWave currently corresponds to bands of spectrum near 38 GHz, 60 GHx and 94 GHz, and in particular to bands between 70 GHz and 90 GH.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary wireless device (such as station (STA) and/or access point (AP))/circuit configuration;

FIG. 2 illustrates a flowchart illustrating an exemplary method for narrowband transmission coexistence.

### DESCRIPTION OF EMBODIMENTS

Today's IEEE 802.11 devices operating in the 2.4/5 GHz bands use a 20 MHz channel as a basic operation unit to maintain coexistence with other 802.11 devices. One exemplary aspect is directed toward using a narrower signal bandwidth (e.g. 2 MHz) in the 2.4/5 GHz bands to reduce transmit/receive power consumption or increase transmission range. While the exemplary embodiments will be directed toward a 2 MHz narrow bandwidth signal, it should be appreciated that the narrow bandwidth signal can be any value such as 1 MHz, 4 MHz, 5 MHz, 10 MHz, 12 MHz, 15 MHz, etc.

One problem with introducing a narrow bandwidth signal is how to maintain the coexistence between a legacy IEEE 802.11 device that uses a 20 MHz signal bandwidth and a new IEEE 802.11 device that uses a narrower signal bandwidth.

For example, when a narrowband IEEE 802.11 device (NB device) has data to transmit, the NB device needs to sense the wireless medium to check if the medium is idle so that the transmission from the narrowband IEEE 802.11 device does not interfere with data reception at a legacy IEEE 802.11 device.

Let's assume that there is a 20 MHz transmission from a legacy IEEE 802.11 device. The received power over the 20 MHz signal bandwidth at the location of a NB device is X dBm. If the NB device only senses its operating signal bandwidth (i.e., 2 MHz), the NB device will sense Y dBm, which is 10 dB less than the total power, i.e. Y=X−10 dB.

If the CCA_ED (clear channel assessment, energy detection) threshold of the NB device is Z dBm and X>Z but Y<Z, then the NB device will transmit a data packet on top of the packet transmission of the legacy IEEE 802.11 device, which may cause collision at the receiver of the legacy IEEE 802.11 device.

Carrier Sense (CS) is a fundamental part of wireless networks, and in particular Wi-Fi networks. Since Wi-Fi communicates information over a shared medium, random access to the medium is available to all stations within the network. As such, carrier sense and medium contention are fundamental to network operation and efficiency in order to avoid collisions and interference.

Wi-Fi carrier sense includes two steps—clear channel assessment (CCA) and network allocation vector (NAV). In general, CCA is a physical carrier sense which measures received energy in the radio spectrum. NAV is a virtual carrier sense which is generally used by wireless stations to reserve certain portions of the medium for mandatory transmission that would occur after a first transmission. In general, CCA assessment is for determining whether the medium is busy for a current frame and NAV is utilized to determine whether the medium will be busy for future frames.

CCA is defined by IEEE 802.11-2007 and includes two interrelated functions—carrier sense (CS) and energy detection (ED). Carrier sense is functionality performed by the receiver to detect and decode an incoming Wi-Fi preamble signal. The CCA is indicated as busy when another Wi-Fi preamble signal is detected and held in the busy state based on information in the length field of the preamble.

Energy detection (ED) occurs when a receiver detects a non-Wi-Fi energy level present on a channel (within a frequency range) based on a noise floor, ambient energy, interference sources, and unidentifiable Wi-Fi transmissions that, for example, cannot be decoded, or the like. ED samples the medium every time slot to determine whether energy is present and, based on a threshold, reports as to whether it is believed that the medium is busy.

In addition to the CCA identifying whether the medium is idle or busy for a current frame and noise, the NAV allows stations to indicate an amount of time required for transmission of mandatory frames following transmission of a current frame. NAV is a critical component of Wi-Fi to ensure the medium is reserved for frames that are essential to the operation of the 802.11 protocol. As discussed in the IEEE 802.11 standard, NAV is carried in the IEEE 802.11 MAC header duration field and encoded at a variable data rate. The station that receives the NAV header duration field can use this information to wait the specified period until the medium is free.

One exemplary embodiment is directed toward having a NB device perform a 20 MHz CCA for a short time period (i.e., DIFS+CW backoff) (DCF Interframe Space+Contention Window) before switching to a narrowband signal transmission so that the NB device measures a power over 20 MHz correctly and does not cause interference to legacy 802.11 devices operating in 20 MHz. IEEE 802.11 the contention window (CW) is adapted dynamically depending on the occurrence of collisions. After each collision, the CW is doubled and thus the CW varies from CWmin to CWmax. For example, the minimum contention window size in the 2.4 GHz band for various standards is as follows: IEEE 802.11-1997 (CWmin=31), IEEE 802.11b-1999 (CWmin=31), IEEE 802.11g-2003 (CWmin=31 for long time slot and 15 for short time slot), IEEE 802.11 DSSS (CWmin=31) and 802.11n-2009 (CWmin=15 for 2.4 GHz). Similarly, the minimum contention window size for the 5 GHz band is as follows: 802.11a-1999 (CWmin=15), IEEE 802.11n-2009 (CWmin=15), and IEEE 802.11ac (CWmin=15).

Currently, narrowband operation in the 2.4/5 GHz bands perform CCA over the operating channel bandwidth, which results in much less power than the actual received power from a legacy IEEE 802.11 device. (e.g., 10 dB less power when measuring over 2 MHz when there is a 20 MHz signal)

In accordance with one exemplary embodiment, since a NB device performs CCA over a 20 MHz channel within which the NB device is operating, the NB device can measure the correct received power from a 20 MHz legacy IEEE 802.11 device and establish a correct back-off.

Since the time the NB device operates in the 20 MHz CCA sensing mode is very short (e.g., DIFS+CW=34 usec+7x9usec=97 usec) compared to a narrowband data transmission time (200 byte×8 bits/600 kbps=2.7 msec), operating in the 20 MHz CCA mode has little effect on the power consumption of the NB device.

An exemplary embodiment for a packet transmission procedure of a NB device includes:
1. Before a narrowband signal transmission (e.g., 2 MHz), a NB device performs CCA over the 20 MHz channel within which the NB device is operating. For example, if the NB device is operating within channel #1 of the 2.4 GHz band, the NB device measures power within channel #1.
2. The NB device follows the CCA and back-off procedure defined in the 802.11 standard, i.e., sensing the wireless medium for DIFS+CW time.
3. If the measured power during the DIFS+CW time is less than the CCA_ED (energy detection threshold), the NB device transmits a narrowband packet.
4. If, however, the measured power during the DIFS+CW time is higher than the CCA_ED, the NB device defers its transmission by following the backoff procedure as defined in the IEEE 802.11 standard.

The IEEE 802.11 family of standards define a Distributed Coordination Function (DCF) protocol, which controls access to the physical medium.

A station must sense the status of the wireless medium before transmitting. If the station determines that the medium is continuously idle for a DCF Interframe Space (DIFS) duration, then the station is permitted to transmit a frame. However, if the channel is found busy during the DIFS interval, the station should defer its transmission.

The DIFS duration can be calculated in accordance with the following:

DIFS=SIFS+(2*Slot time)(where SIFS is the Short Interframe Space)

The table below illustrates the DIFS for various IEEE Standards.

| Standard | Slot time (μs) | DIFS (μs) |
|---|---|---|
| IEEE 802.11- | 50 | 128 |
| 1997 (FHSS) | | |
| IEEE 802.11- | 20 | 50 |
| 1997 (DSSS) | | |
| IEEE 802.11b | 20 | 50 |
| IEEE 802.11a | 9 | 34 |
| IEEE 802.11g | 9 or 20 | 28 or 50 |
| IEEE 802.11n (2.4 GHz) | 9 or 20 | 28 or 50 |
| IEEE 802.11n (5 GHz) | 9 | 34 |
| IEEE 802.11ac (5 GHz) | 9 | 34 |

The Distributed Coordination Function (DCF) is the fundamental MAC technique of the IEEE 802.11 based WLAN standard. DCF employs a Carrier Sense Multiple Access with Collision Avoidance (CSMA/CA) with a binary exponential backoff algorithm.

DCF requires a station wishing to transmit to listen for the channel status for a DIFS interval. If the channel is found busy during the DIFS interval, the station defers its transmission. In a network where a number of stations contend for the wireless medium, if multiple stations sense the channel busy and defer their access, they will also virtually simultaneously find that the channel is released and then try to seize the channel. As a result, collisions may occur.

In order to avoid such collisions, DCF also specifies a random backoff, which forces a station to defer its access to the channel for an extra period. The length of the backoff period is determined by the following equation:

BackoffTime=random( )×aSlotTime

DCF also has an optional virtual carrier sense mechanism that exchanges short Request-to-send (RTS) and Clear-to-send (CTS) frames between source and destination stations during the intervals between the data frame transmissions. DCF also includes a positive acknowledge scheme, which means that if a frame is successfully received by the destination it is addressed to, the destination needs to send an ACK frame to notify the source of the successful reception.

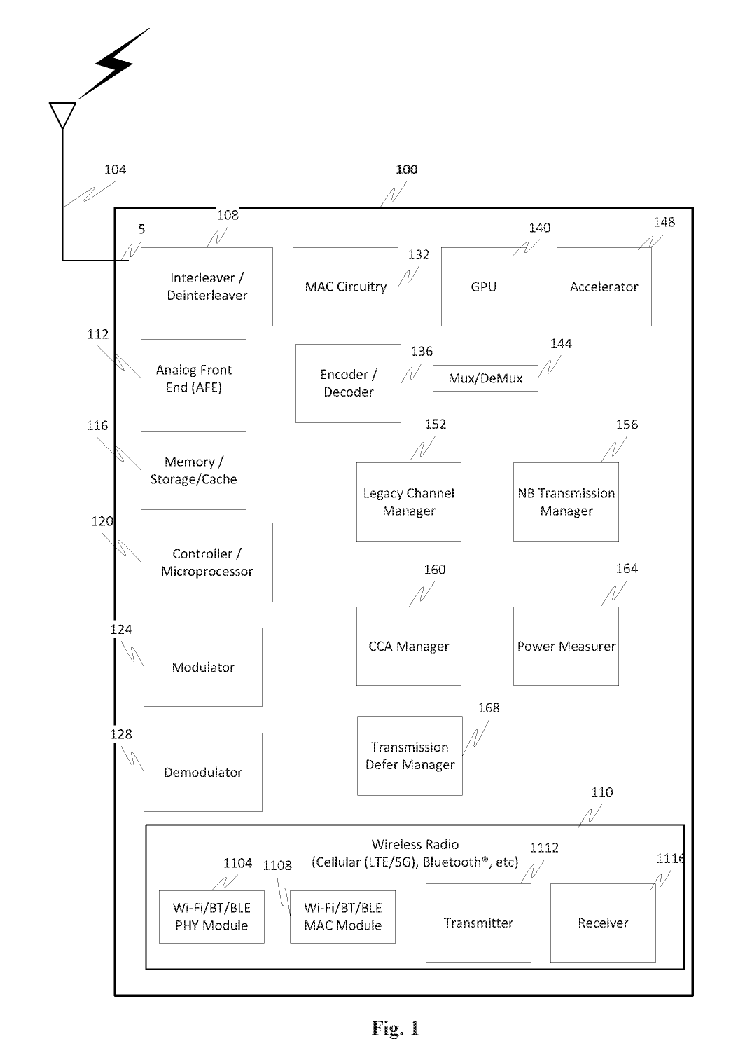

FIG. 1 illustrates an exemplary hardware/functional block diagram of a device 100, such as a wireless device, mobile device, access point (AP), station (STA), or the like, that is adapted to implement the technique(s) discussed herein.

In addition to well-known componentry (which has been omitted for clarity), the device 100 includes interconnected elements including one or more of: one or more antennas 104 and associated antenna ports, an interleaver/deinterleaver 108, an analog front end (AFE) 112, memory/storage/cache 116, controller/microprocessor 120, MAC circuitry 132, modulator 124, demodulator 128, encoder/decoder 136, GPU 140, accelerator 148, a multiplexer/demultiplexer 144, a legacy channel manager 152, a narrowband transmission manager 156, a CCA manager 160, a power measurer 164, a transmission defer manager 168 and wireless radio 110 components such as a Wi-Fi/BT PHY module/circuit 1104, a Wi-Fi/BT MAC module/circuit 1108, transmitter 1112 and receiver 1116. The various elements in the device 100 are connected by one or more links/connections 5 (not all shown, again for sake of clarity).

In IEEE 802.11n, transmitter and receiver cooperate with the encoder and decoder, respectively, and use precoding and postcoding techniques, respectively, to achieve the capacity of a MIMO link. Precoding includes spatial beamforming and spatial coding, where spatial beamforming improves the received signal quality at the decoding stage. Spatial coding can increase data throughput via spatial multiplexing and increase range by exploiting the spatial diversity. The accelerator 148 can cooperate with the MAC circuitry 132 to, for example, perform real-time MAC functions. The GPU 140 is a specialized electronic circuit designed to rapidly manipulate and alter memory to accelerate the creation of data such as images in a frame buffer. GPUs are typically used in embedded systems, mobile phones, personal computers, workstations, and game consoles. GPUs are very efficient at manipulating computer graphics and image processing, and their highly parallel structure makes them more efficient than general-purpose CPUs for algorithms where the processing of large blocks of data is done in parallel.

The device 100 can have one more antennas 104, for use in wireless communications such as Wi-Fi, multi-input multi-output (MIMO) communications, multi-user multi-input multi-output (MU-MIMO) communications Bluetooth®, LTE, 4G, 5G, 60 Ghz, WiGig, mmWave systems, etc. The antenna(s) 104 can include, but are not limited to one or more of directional antennas, omnidirectional antennas, monopoles, patch antennas, loop antennas, microstrip antennas, dipoles, and any other antenna(s) suitable for communication transmission/reception. In one exemplary embodiment, transmission/reception using MIMO may require particular antenna spacing. In another exemplary embodiment, MIMO transmission/reception can enable spatial diversity allowing for different channel characteristics at each of the antennas. In yet another embodiment, MIMO transmission/reception can be used to distribute resources to multiple users.

Antenna(s) 104 generally interact with the Analog Front End (AFE) 112, which is needed to enable the correct processing of the received modulated signal and signal conditioning for a transmitted signal. The AFE 112 can be functionally located between the antenna and a digital baseband system in order to convert the analog signal into a digital signal for processing, and vice-versa.

The device 100 can also include a controller/microprocessor 120 in communication with a memory/storage/cache 116. The device 100 can interact with the memory/storage/cache 116 which may store information and operations necessary for configuring and transmitting or receiving the information and performing one or more portions of the techniques described herein. The memory/storage/cache 116 may also be used in connection with the execution of application programming or instructions by the controller/microprocessor 120, and for temporary or long term storage of program instructions and/or data. As examples, the memory/storage/cache 120 may comprise a computer-readable device, RAM, ROM, DRAM, SDRAM, and/or other storage device(s) and media.

The controller/microprocessor 120 may comprise a general purpose programmable processor or controller for executing application programming or instructions related to the device 100. Furthermore, the controller/microprocessor 120 can cooperate with one or more other elements in the device 100 to perform operations for configuring and transmitting information and performing operations as described herein. The controller/microprocessor 120 may include multiple processor cores, and/or implement multiple virtual processors. Optionally, the controller/microprocessor 120 may include multiple physical processors. By way of example, the controller/microprocessor 120 may comprise a specially configured Application Specific Integrated Circuit (ASIC) or other integrated circuit, a digital signal processor(s), a controller, a hardwired electronic or logic circuit, a programmable logic device or gate array, a special purpose computer, or the like.

The device 100 can further include a transmitter 1112 and receiver 1116 which can transmit and receive signals, respectively, to and from other wireless devices and/or access points using the one or more antennas 104. Included in the device 100 circuitry is the medium access control or MAC Circuitry 132. MAC circuitry 132 provides for controlling access to the wireless medium. In an exemplary embodiment, the MAC circuitry 132 may be arranged to contend for the wireless medium and configure frames or packets for communicating over the wireless medium.

The device 100 can also optionally contain a security module (not shown). This security module can contain information regarding but not limited to, security parameters required to connect the device to an access point or other device, or vice versa, or other available network(s), and can include WEP or WPA/WPA-2 (optionally+AES and/or TKIP) security access keys, network keys, etc. As an example, the WEP security access key is a security password used by Wi-Fi networks. Knowledge of this code can enable a wireless device to exchange information with the access point and/or another device. The information exchange can occur through encoded messages with the WEP access code often being chosen by the network administrator. WPA is an added security standard that is also used in conjunction with network connectivity with stronger encryption than WEP.

As shown in FIG. 1, the exemplary device 100 can also include a GPU 140, an accelerator 148, multiplexer/demultiplexer 144, a Wi-Fi/BT (Bluetooth®)/BLE (Bluetooth® Low Energy) PHY module 1104 and a Wi-Fi/BT/BLE MAC module 1108 that at least cooperate with one or more of the other components as discussed herein.

In operation, the device 100 performs normal (legacy) IEEE 802.11 communications in conjunction with the legacy channel manager 152, MAC circuitry 132 and wireless radio components 110. When the NB transmission manager 156 determines that a narrowband transmission should occur (e.g., 2 MHz), the CCA manager 160 performs a CCA over a 20 MHz channel (or other legacy channel bandwidth depending on the implementation) within which the device 100 is operating. For example, if the NB device is operating within channel #2 of the 5 GHz band, the NB device measures power within channel #2.

The device 100 then follows the CCA and backoff procedure as managed by the CCA manager 160 for the CCA over the 20 MHz channel. As discussed, this can include sensing the wireless medium for DIFS+CW time.

If the power measurer 164 determines that the measured power during the DIFS+CW time is less than the CCA_ED (energy detection threshold), the device 100 transmits a narrowband packet.

If the power measurer 164 determines however that the measured power during the DIFS+CW time is higher than the CCA_ED, the device 100 defers its transmission (in cooperation with the transmission defer manager 168) by following the backoff procedure as, for example, defined in the IEEE 802.11 standard.

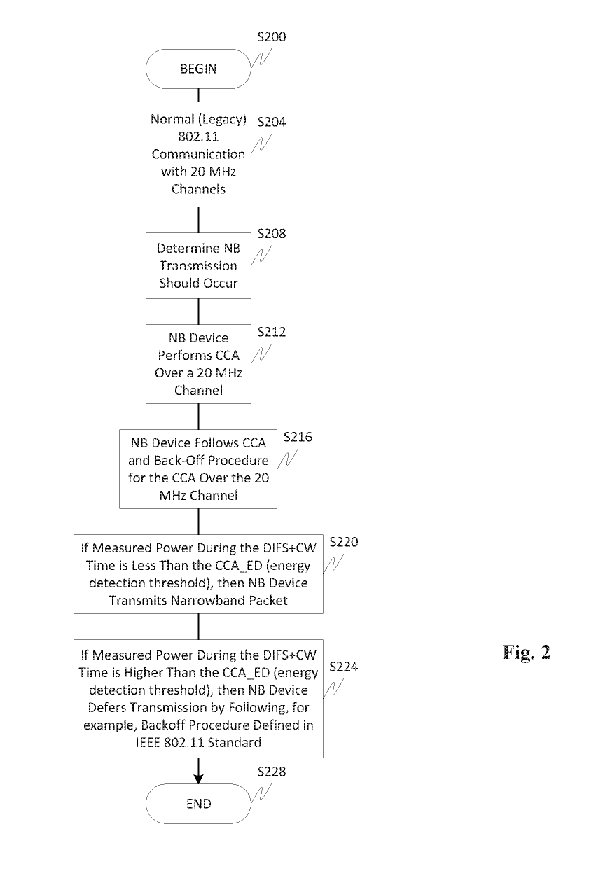

FIG. 2 outlines an exemplary method for NB device operation. Control begins in step S200 and continues to step S204. In step S204, normal (legacy) IEEE 802.11 communications can be performed. Next, in step S208, a determination is made whether a narrowband transmission should occur (e.g., 2 MHz). When a narrowband transmission should occur, a CCA is performed in Step S212 over a 20 MHz channel (or other legacy channel bandwidth depending on the implementation) within which the device is operating. For example, if the NB device is operating within channel #1 of the 5 GHz band, the NB device measures power within channel #1.

The NB device, in step S216, then follows the CCA and backoff procedure for the CCA over the 20 MHz channel. As discussed, this can include sensing the wireless medium for DIFS+CW time. Control then continues to step S220.

In step S220, and if it is determined that the measured power during the DIFS+CW time is less than the CCA_ED (energy detection threshold), the device transmits a narrowband packet.

In step S224, and if it is determined that the measured power during the DIFS+CW time is higher than the CCA_ED, the device defers its transmission by following, for example, the backoff procedure as, for example, defined in the IEEE 802.11 standard.

Control then continues to step S228 where the control sequence ends.

In the detailed description, numerous specific details are set forth in order to provide a thorough understanding of the disclosed techniques. However, it will be understood by those skilled in the art that the present techniques may be practiced without these specific details. In other instances, well-known methods, procedures, components and circuits have not been described in detail so as not to obscure the present disclosure.

Although embodiments are not limited in this regard, discussions utilizing terms such as, for example, “processing,” “computing,” “calculating,” “determining,” “establishing”, “analysing”, “checking”, or the like, may refer to operation(s) and/or process(es) of a computer, a computing platform, a computing system, a communication system or subsystem, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, circuits, or the like. For example, “a plurality of stations” may include two or more stations.

It may be advantageous to set forth definitions of certain words and phrases used throughout this document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, interconnected with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, circuitry, firmware or software, or some combination of at least two of the same. It should be noted that the functionality associated with any particular controller may be centralized or distributed, whether locally or remotely. Definitions for certain words and phrases are provided throughout this document and those of ordinary skill in the art should understand that in many, if not most instances, such definitions apply to prior, as well as future uses of such defined words and phrases.

The exemplary embodiments will be described in relation to communications systems, as well as protocols, techniques, means and methods for performing communications, such as in a wireless network, or in general in any communications network operating using any communications protocol(s). Examples of such are home or access networks, wireless home networks, wireless corporate networks, and the like. It should be appreciated however that in general, the systems, methods and techniques disclosed herein will work equally well for other types of communications environments, networks and/or protocols.

For purposes of explanation, numerous details are set forth in order to provide a thorough understanding of the present techniques. It should be appreciated however that the present disclosure may be practiced in a variety of ways beyond the specific details set forth herein. Furthermore, while the exemplary embodiments illustrated herein show various components of the system collocated, it is to be appreciated that the various components of the system can be located at distant portions of a distributed network, such as a communications network, node, within a Domain Master, and/or the Internet, or within a dedicated secured, unsecured, and/or encrypted system and/or within a network operation or management device that is located inside or outside the network. As an example, a Domain Master can also be used to refer to any device, system or module that manages and/or configures or communicates with any one or more aspects of the network or communications environment and/or transceiver(s) and/or stations and/or access point(s) described herein.

Thus, it should be appreciated that the components of the system can be combined into one or more devices, or split between devices, such as a transceiver, an access point, a station, a Domain Master, a network operation or management device, a node or collocated on a particular node of a distributed network, such as a communications network. As will be appreciated from the following description, and for reasons of computational efficiency, the components of the system can be arranged at any location within a distributed network without affecting the operation thereof. For example, the various components can be located in a Domain Master, a node, a domain management device, such as a MIB, a network operation or management device, a transceiver(s), a station, an access point(s), or some combination thereof. Similarly, one or more of the functional portions of the system could be distributed between a transceiver and an associated computing device/system.

Furthermore, it should be appreciated that the various links, including the communications channel(s) connecting the elements, can be wired or wireless links or any combination thereof, or any other known or later developed element(s) capable of supplying and/or communicating data to and from the connected elements. The term module as used herein can refer to any known or later developed hardware, circuitry, software, firmware, or combination thereof, that is capable of performing the functionality associated with that element. The terms determine, calculate, and compute and variations thereof, as used herein are used interchangeable and include any type of methodology, process, technique, mathematical operational or protocol.

Moreover, while some of the exemplary embodiments described herein are directed toward a transmitter portion of a transceiver performing certain functions, or a receiver portion of a transceiver performing certain functions, this disclosure is intended to include corresponding and complementary transmitter-side or receiver-side functionality, respectively, in both the same transceiver and/or another transceiver(s), and vice versa.

The exemplary embodiments are described in relation to enhanced GFDM communications. However, it should be appreciated, that in general, the systems and methods herein will work equally well for any type of communication system in any environment utilizing any one or more protocols including wired communications, wireless communications, powerline communications, coaxial cable communications, fiber optic communications, and the like.

The exemplary systems and methods are described in relation to IEEE 802.11 and/or Bluetooth® and/or Bluetooth® Low Energy transceivers and associated communication hardware, software and communication channels. However, to avoid unnecessarily obscuring the present disclosure, the following description omits well-known structures and devices that may be shown in block diagram form or otherwise summarized.

Exemplary aspects are directed toward:

A wireless communications device having narrowband and legacy device compatibility comprising:
a narrowband transmission manager and processor which determine that a narrowband transmission of a narrowband packet should occur;
a clear channel assessment (CCA) manager which performs a CCA over a legacy channel bandwidth;
a power measurer which determines a measured power during a period of time and:
when a measured power during the period of time is less than a CCA energy detection threshold, a transmitter of the device transmits a narrowband packet, or
when the measured power during the period of time is higher than the CCA energy detection threshold, a transmission defer manager defers transmission of the narrowband packet.
Any of the above aspects, wherein the period of time is based on a Distributed Coordination Function Interframe Space (DIFS) and Contention Window (CW).
Any of the above aspects, wherein the narrowband transmission is in a 2 MHz channel and the legacy channel bandwidth is 20 MHz.
Any of the above aspects, wherein the DIFS=SIFS+(2*Slot time), wherein SIFS is a Short Interframe Space.
Any of the above aspects, wherein the transmitter transmits in a legacy channel bandwidth.
Any of the above aspects, wherein the measured power is measured within a channel in which the device is operating.
Any of the above aspects, wherein the device operates in 2.4/5 GHz bands.
Any of the above aspects, further comprising one or more connected elements including a receiver, an interleaver/deinterleaver, an analog front end, a GPU, an accelerator, an encoder/decoder, one or more antennas, and memory.
Any of the above aspects, wherein the device operates in 2.4/5 GHz bands and the device uses a 20 MHz channel as a basic operation unit.
A non-transitory information storage media having stored thereon one or more instructions, that when executed by one or more processors, cause a wireless communications device to perform a method comprising:
determining that a narrowband transmission of a narrowband packet should occur;
   performing a CCA over a legacy channel bandwidth;
   determining a measured power during a period of time and:
when a measured power during the period of time is less than a CCA energy detection threshold, a transmitter of the device transmits a narrowband packet, or
when the measured power during the period of time is higher than the CCA energy detection threshold, a transmission defer manager defers transmission of the narrowband packet.
Any of the above aspects, wherein the period of time is based on a Distributed Coordination Function Interframe Space (DIFS) and Contention Window (CW).
Any of the above aspects, wherein the narrowband transmission is in a 2 MHz channel and the legacy channel bandwidth is 20 MHz.
Any of the above aspects, wherein the DIFS=SIFS+(2*Slot time), wherein SIFS is a Short Interframe Space.
Any of the above aspects, wherein the transmitter transmits in a legacy channel bandwidth.
Any of the above aspects, wherein the measured power is measured within a channel in which the device is operating.
Any of the above aspects, wherein the device operates in 2.4/5 GHz bands.
Any of the above aspects, wherein the device operates in 2.4/5 GHz bands and the device uses a 20 MHz channel as a basic operation unit.
A wireless communications device, the device comprising: memory and processor circuitry configured to:
   determine that a narrowband transmission of a narrowband packet should occur;
   perform a CCA over a legacy channel bandwidth;
   determine a measured power during a period of time and:
when a measured power during the period of time is less than a CCA energy detection threshold, a transmitter of the device transmits a narrowband packet, or
when the measured power during the period of time is higher than the CCA energy detection threshold, a transmission defer manager defers transmission of the narrowband packet.
Any of the above aspects, wherein the period of time is based on a Distributed Coordination Function Interframe Space (DIFS) and Contention Window (CW).
Any of the above aspects, wherein the DIFS=SIFS+(2*Slot time), wherein SIFS is a Short Interframe Space.
A wireless communications device, the device comprising:
   means for determining that a narrowband transmission of a narrowband packet should occur;
   means for performing a CCA over a legacy channel bandwidth;
   means for determining a measured power during a period of time and:
when a measured power during the period of time is less than a CCA energy detection threshold, a transmitter of the device transmits a narrowband packet, or
when the measured power during the period of time is higher than the CCA energy detection threshold, a transmission defer manager defers transmission of the narrowband packet.
Any of the above aspects, wherein the period of time is based on a Distributed Coordination Function Interframe Space (DIFS) and Contention Window (CW).
Any of the above aspects, wherein the DIFS=SIFS+(2*Slot time), wherein SIFS is a Short Interframe Space.

A system on a chip (SoC) including any one or more of the above aspects.

One or more means for performing any one or more of the above aspects.

Any one or more of the aspects as substantially described herein.

For purposes of explanation, numerous details are set forth in order to provide a thorough understanding of the present embodiments. It should be appreciated however that the techniques herein may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a communications network and/or the Internet, or within a dedicated secure, unsecured and/or encrypted system. Thus, it should be appreciated that the components of the system can be combined into one or more devices, such as an access point or station, or collocated on a particular node/element(s) of a distributed network, such as a telecommunications network. As will be appreciated from the following description, and for reasons of computational efficiency, the components of the system can be arranged at any location within a distributed network without affecting the operation of the system. For example, the various components can be located in a transceiver, an access point, a station, a management device, or some combination thereof. Similarly, one or more functional portions of the system could be distributed between a transceiver, such as an access point(s) or station(s) and an associated computing device.

Furthermore, it should be appreciated that the various links, including communications channel(s), connecting the elements (which may not be not shown) can be wired or wireless links, or any combination thereof, or any other known or later developed element(s) that is capable of supplying and/or communicating data and/or signals to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

While the above-described flowcharts have been discussed in relation to a particular sequence of events, it should be appreciated that changes to this sequence can occur without materially effecting the operation of the embodiment(s). Additionally, the exact sequence of events need not occur as set forth in the exemplary embodiments, but rather the steps can be performed by one or the other transceiver in the communication system provided both transceivers are aware of the technique being used for initialization. Additionally, the exemplary techniques illustrated herein are not limited to the specifically illustrated embodiments but can also be utilized with the other exemplary embodiments and each described feature is individually and separately claimable.

The above-described system can be implemented on a wireless telecommunications device(s)/system, such an IEEE 802.11 transceiver, or the like. Examples of wireless protocols that can be used with this technology include IEEE 802.11a, IEEE 802.11b, IEEE 802.11g, IEEE 802.11n, IEEE 802.11ac, IEEE 802.11ad, IEEE 802.11af, IEEE 802.11ah, IEEE 802.11ai, IEEE 802.11aj, IEEE 802.11aq, IEEE 802.11ax, Wi-Fi, LTE, 4G, Bluetooth®, WirelessHD, WiGig, WiGi, 3GPP, Wireless LAN, WiMAX, and the like.

The term transceiver as used herein can refer to any device that comprises hardware, software, circuitry, firmware, or any combination thereof and is capable of performing any of the methods, techniques and/or algorithms described herein.

Additionally, the systems, methods and protocols can be implemented to improve one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can benefit from the various communication methods, protocols and techniques according to the disclosure provided herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the embodiments is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed methods may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

It is therefore apparent that there has at least been provided systems and methods for enhancing and improving communications. While the embodiments have been described in conjunction with a number of embodiments, it is evident that many alternatives, modifications and variations would be or are apparent to those of ordinary skill in the applicable arts. Accordingly, this disclosure is intended to embrace all such alternatives, modifications, equivalents and variations that are within the spirit and scope of this disclosure.

1. A wireless communications device having narrowband and legacy device compatibility comprising:
a narrowband transmission manager in the communications device that determines that a narrowband transmission of a narrowband packet should occur;
a clear channel assessment (CCA) manager in the communications device which performs a CCA over a legacy channel bandwidth;
a power measurer in the communications device which determines a measured power during a period of time and:
when a measured power during the period of time is less than a CCA energy detection threshold, a transmitter of the device transmits a narrowband packet, or
when the measured power during the period of time is higher than the CCA energy detection threshold, a transmission defer manager defers transmission of the narrowband packet.

2. The wireless communications device of claim 1, wherein the period of time is based on a Distributed Coordination Function Interframe Space (DIFS) and Contention Window (CW).

3. The wireless communications device of claim 1, wherein the narrowband transmission is in a 2 MHz channel and the legacy channel bandwidth is 20 MHz.

4. The wireless communications device of claim 2, wherein the DIFS=SIFS+(2*Slot time), wherein SIFS is a Short Interframe Space.

5. The wireless communications device of claim 1, wherein the transmitter transmits in a legacy channel bandwidth.

6. The wireless communications device of claim 1, wherein the measured power is measured within a channel in which the device is operating.

7. The wireless communications device of claim 1, wherein the device operates in 2.4/5 GHz bands.

8. The wireless communications device of claim 1, further comprising one or more connected elements including a receiver, an interleaver/deinterleaver, an analog front end, a GPU, an accelerator, an encoder/decoder, one or more antennas, and memory.

9. The wireless communications device of claim 1, wherein the device operates in 2.4/5 GHz bands and the device uses a 20 MHz channel as a basic operation unit.

10. A non-transitory information storage media having stored thereon one or more instructions, that when executed by one or more processors, cause a wireless communications device to perform a method comprising:
determining that a narrowband transmission of a narrowband packet should occur;
performing a CCA over a legacy channel bandwidth;
determining a measured power during a period of time and:
when a measured power during the period of time is less than a CCA energy detection threshold, a transmitter of the device transmits a narrowband packet, or
when the measured power during the period of time is higher than the CCA energy detection threshold, a transmission defer manager defers transmission of the narrowband packet.

11. The media of claim 10, wherein the period of time is based on a Distributed Coordination Function Interframe Space (DIFS) and Contention Window (CW).

12. The media of claim 10, wherein the narrowband transmission is in a 2 MHz channel and the legacy channel bandwidth is 20 MHz.

13. The media of claim 12, wherein the DIFS=SIFS+(2*Slot time), wherein SIFS is a Short Interframe Space.

14. The media of claim 10, wherein the transmitter transmits in a legacy channel bandwidth.

15. The media of claim 10, wherein the measured power is measured within a channel in which the device is operating.

16. The media of claim 10, wherein the device operates in 2.4/5 GHz bands.

17. The media claim 10, wherein the device operates in 2.4/5 GHz bands and the device uses a 20 MHz channel as a basic operation unit.

18. A wireless communications device, the device comprising:
memory and processor circuitry in the communications device configured to:
determine that a narrowband transmission of a narrowband packet should occur;
perform a CCA over a legacy channel bandwidth;
determine a measured power during a period of time and:
when a measured power during the period of time is less than a CCA energy detection threshold, a transmitter of the device transmits a narrowband packet, or
when the measured power during the period of time is higher than the CCA energy detection threshold, a transmission defer manager defers transmission of the narrowband packet.

19. The device of claim 18, wherein the period of time is based on a Distributed Coordination Function Interframe Space (DIFS) and Contention Window (CW).

20. The device of claim 18, wherein the DIFS=SIFS+(2*Slot time), wherein SIFS is a Short Interframe Space.
